(19) United States
(12) Patent Application Publication
(10) Pub. No.: US 2008/0232973 A1
(43) Pub. Date: Sep. 25, 2008

(54) Propeller blade

(75) Inventor: Marty Allen Ferman, St. Louis, MO (US)

Correspondence Address: SAINT LOUIS UNIVERSITY;OFFICE OF INNOVATION AND INTELLECTUAL PROPERTY, 3556 CAROLINE MALL, SUITE C208, ST. LOUIS, MO, 63104, US

(73) Assignee: Saint Louis University

(21) Appl. No.: 11/454,090

(22) Filed: Jun. 15, 2006

Related U.S. Application Data
(60) Provisional application No. 60/701,462, filed on Jul. 21, 2005.

(51) Int. Cl. B64C 11/16

(52) U.S. Cl. 416/236 R

(57) ABSTRACT

An improved propeller blade is presented. The improved blade has a slot near the tip. This improved blade outperforms and is more efficient than other modified and unmodified blade tip configurations.

This application claims benefit of priority to U.S. Provisional Patent Application No. 60,01,462, which was filed on Jul. 21, 2005.

### BACKGROUND OF THE INVENTION

1. Field of the Invention

This invention relates to an improved propeller blade for use in wind turbines, wind mills, aircraft, or watercraft. Specifically, this invention relates to a propeller blade(s) having modifications at or near the tip that allows for more efficient energy transfer and conversion, resulting in greater thrust or propulsive power, or improved power developed for an electrical generator.

2. Description of the Related Art

The harnessing of wind energy by man for useful purposes, such as in wind mills, spans many millennia. Basic designs for wind mills include the ancient Vertical Axis Wind Mills, VAWM, where the rotation axis is vertical, and the more modern European Wind Mills that were modified to have the rotation axis parallel to the ground, i.e., Horizontal Axis Wind Mills, HAWM. Because these early designs actually milled grain, they are properly referred to as “Wind Mills.” In the 1800's when practical electrical power was discovered, designs to use wind power began to arrive on the scene. These devices are properly referred to as Wind Turbines. Those with the horizontal axes are called Horizontal Axis Wind Turbines, HAWT, while those with the vertical axes are called Vertical Axis Wind Turbines, VAWT. Both HAWT and VAWT are in use today.

Presently, wind turbines generate approximately 3% of the total electricity produced in the U.S. The high cost of wind power plants due to the relative immaturity of the technology has prevented the spread of wind power plants. Modern wind turbines range in configuration and power capacities, the vertical axis configuration and the 100 to 500 KW power range being the most commercially common. The trend in the market is to build the largest possible wind turbines. Some state-of-the-art models, such as Boeing Co.'s 3.2 MW wind turbine, rate several megawatts of power output capacity.

A long felt need exists to make electrical power from wind generation more efficient. One way to obtain greater efficiency in wind power devices is to reduce the drag caused by the propeller blades. Another way to obtain greater efficiency in wind power is to reduce the intensity of the trailing vortex generated by the propeller blades.

### SUMMARY OF THE INVENTION

The inventor conceived that aircraft wing tip devices could have similar effects on wind turbine propeller blades. In aircraft wings, trailing edge vortices are formed by the communication of the low and high pressure regions of the lifting surface, especially at the tip. The downwash velocity caused by this pressure equalization induces increased drag on the wing. Winglets and other wing tip devices are aimed at alleviating this induced drag by limiting the rotational velocity at the tip vortex and in the trailing vortex.

The strength of the trailing vortex and the amount of drag that it causes on an aircraft is proportional to the weight of the aircraft and the wing size. In a wind turbine propeller blade configuration, the strength of a trailing vortex can be reduced. Different blade tip modifications may be used to reduce the level of the vortex, or to redistribute the high intensity locations, as well as to modify the frequency distributions of trailing vortices. Such blade tip devices should reduce drag, thus increasing thrust or generated power. Blade tip devices that were explored include winglets, trailing edge perforations, radial slots, and tip cylinders.

Slots and holes in wings have known effects in wing aerodynamics. In the F/A-18, slots in the wing leading edge extension (LEX) were used to mitigate buffet due to the air flow through a slot. This added flow causes the wing vortex flow to be re-energized as it moves aft, thus reducing the flow disturbances from vortex bursting, and hence mitigating buffet effects on the vertical tails.

The inventor discovered that by modifying propeller blades, especially at or near the tips of the blades, the efficiency of conversion of fluid dynamic energy (e.g., wind and water power) to usable energy, such as electricity, by a wind turbine, significantly improves. Thus, the invention is directed to an improved propeller and improved propeller blade having greater power output and power coefficients; to a method of generating power using an improved propeller blade; and to a method of propulsion using an improved propeller blade.

Three different descriptions of measurement are helpful when describing a size, shape or location within a propeller blade. These three measures are twist, radius, and chord. Blades are twisted such that the angle of attack increases as the distance from the central hub increases. The radius of a blade is the distance from the central hub to the point on the blade that is farthest from the central hub. The point on a blade that is farthest from the central hub is also known as the tip. The chord of a blade can also be thought of as its width. Chord is the distance from the leading edge, to the trailing edge, at a single radius of a blade. Chord may be measured at any radius along the blade.

In one embodiment, the invention is directed to an improved propeller blade(s) having a wing tip modification that increases the power output of a propeller or wind/water turbine comprising the improved propeller blade(s). Preferred wing tip modifications include wing tip tiplets, tip slots, trailing-edge perforations and/or combinations thereof. More preferably, each propeller blade of the propeller comprises a slot of any shape, any chord, any radius, and at any position along the propeller blade. Most preferably, each propeller blade of the propeller comprises a slot located at quarter chord and located near the tip of the blade, spanning from 85% radius to 95% radius (see FIG. 6). The propeller comprising the improved propeller blades may be used to generate power as in a wind or water turbine, and it may be used to power aircraft and/or watercraft as in a propulsion system.

In another embodiment, the invention is directed to a method for producing power, especially electrical power, from the conversion of fluid dynamic energy (wind and/or water) using a wind or water turbine, the wind or water turbine comprising an improved propeller blade(s) as described in the preceding paragraph.

In another embodiment, the invention is directed to a method for propulsion through a fluid, e.g. water and/or air, using a powered propeller, the powered propeller comprising an improved propeller blade(s) as described in the preceding paragraph(s).

### BRIEF DESCRIPTION OF THE DRAWINGS

FIG. 1 depicts the definition of cant angle.

FIG. 2 depicts an unmodified propeller blade model used as a base model for the purpose of comparing modified propeller blade models.

FIG. 3 depicts a modified propeller blade model, the modification comprising a wing tiplet at or near each of the blade tips.

FIG. 4 depicts a modified propeller blade model, the modification comprising a series of holes at or near each of the blade tips.

FIG. 5 depicts a modified propeller blade model, the modification comprising a cylinder at or near each of the blade tips.

FIG. 6 depicts a modified propeller blade model, the modification comprising a slot at or near each of the blade tips.

FIG. 7 depicts a Power-Velocity Performance graph. It displays experimentally derived Output Power (W) at various Wind Speeds (m/s) of four modified propeller blade models and an unmodified propeller blade base model.

FIG. 8 depicts a Power-Velocity Performance graph as in FIG. 7 focusing on a small range of lower Wind Speeds (3 to 7 m/s).

FIG. 9 depicts a Power Output graph. It displays experimentally derived Generator Power Output at 10 m/s of four modified propeller blade models and an unmodified propeller blade base model.

FIG. 10 depicts a Power Coefficient graph. It displays experimentally derived Power Coefficients at various Wind Speeds (m/s) of four modified propeller blade models and an unmodified propeller blade base model.

FIG. 11 depicts a Velocity-Power Coefficient graph. It displays experimentally derived [Kp] at various [J] of four modified propeller blade models and an unmodified propeller blade base model.

Figure A depicts wing tip vortices as shed in nominal conditions.

Figure B-1 depicts the concept of the propeller blade with the rotation or angular velocity ω and a forward velocity V.

Figure B-2 depicts the helical motion of a blade section at a distance R above the axis of rotation.

Figure B-3 depicts the vortices at the tips of the blade when the blade is not rotating.

Figure B-4 depicts the effects of rotation, the helical path of the blade tips, with the tip vortices moving along the helical path.

Figure C-1 depicts three circulations through the slot when rotation is ignored.

Figure C-2 depicts three circulations through the slot when rotation is considered.

### DETAILED DESCRIPTION OF A PREFERRED EMBODIMENT OF THE INVENTION

An improved propeller blade is provided. A wind turbine comprising the improved blade produces greater power output and greater power coefficient than a wind turbine comprising unmodified propeller blades. A wind turbine comprising the improved blade also produces greater power output and greater power coefficient than a wind turbine comprising other known blade modifications.

Figure A shows wing tip vortices as shed in nominal conditions. Since the static pressure on the top of a wing is less than that on the bottom, a flow develops that rotates the air around the tip. For a left-hand wing section, such as depicted in Figure A, the flow rotates in a clockwise direction when viewed from behind. For a right-hand wing section, the flow would rotate in the opposite direction, counter-clockwise. These induced rotational flows are generally called tip vortices.

The tip vortices tend to remain for a considerable length of time. As the wing moves forward, the vortex remains in place. The rotation slows due to friction and viscosity, thus widening the vortex diameter. The vortex appears to grow in size to an observer. The vortex has angular momentum due to the rotation and air mass. Gravity pulls the vortex downward. The fuselage (straight wing) or the fuselage and wing (aft-swept wing) cause a flow (or wash) in an outboard direction. This outwards type flow transfers to the vortex, causing the vortex to move outwards. Thus, these tip vortices are also known as trailing vortices, since the wing moves forward relative to the vortices.

This downward and spreading behavior can be readily seen at or near airports when aircraft are flying slowly. It is especially noticeable under certain air conditions where the dew point allows more moisture to be entrapped in the low pressure regions of the vortices (condensation).

The trailing vortices persist for long periods of time and, therefore, for great distances behind the wing. The strength of the vortices is proportional to the weight of the aircraft. Therefore, larger aircraft can produce trailing vortices capable of damaging smaller airplanes. Aircraft must be adequately spaced to avoid such damage.

Propeller vortices are much more complex than those for wings, in part due to the rotational aspect of propellers. The sections of a propeller blade are airfoils, as are the cross sections of a wing. The flow experienced by the blade sections, however, is a mixed flow that combines the nominal flow and that induced by rotation.

The rotating blade sections have an angle of attack affected by the vector of the two components. The nominal flow vector is V. The flow vector due to rotation is V_{R}. V_{R} is defined as Rω, where R is the radial position of a blade section above the rotational axis and ω is the angular rotational velocity of the blade.

The total velocity, V_{T}, is given as:
V_{T}=\sqrt{V²+V_{R}²}.

The blade sections tend to exhibit helical paths as the propeller moves forward along the wind axis, or along V.

Figure B gives some details of the blades section motion, the vortices and combined effects of the helical paths of the blades and the shed (or trailing) vortices. Figure B-1 shows the concept of the propeller blade with the rotation or angular velocity ω and a forward velocity V. The two terms are illustrated by a single vector for V while the ω term is shown by a double headed arrow or vector, using the Right-Hand Rule for vectors. Figure B-2 illustrates the helical motion of a blade section at a distance R above the axis of rotation. In Figure B-3, the vortices at the tips of the blade are shown when the blade is not rotating. Here, the tip and trailing vortices are similar to a wing, while they differ considerably when the propeller is rotating. In Figure B-4, the effects of rotation are shown to produce the helical path of the blade tips, with the tip vortices moving along the helical path.

The trailing vortices are shown to be shedding from the various positions during the helical motions. Stream tubes of these vortices are generated, creating a complex surface shape. The two blade tips cross through the nearly continuous fields of vortex shedding. This cuts the efficiency of the individual blade. A single blade is aerodynamically more efficient, but when blade area and dynamic balance are considered, the two blades are a good comprise. While two blades are used in these figures, it serves illustrative purposes only. One skilled in the art can appreciate the applicability to a propeller of any number of blades.

Similar to the tip vortices of a wing, the angular velocity and mass create a momentum where gravity causes the trailing vortices to move downward. The conditions for the inward or outward movement (contracting or spreading) of the trailing vortices depend on whether the blade is wind-milling (unpowered), or thrusting (powered). However, the effect of rotation of the blade creates a centrifugal force at the tip which tends to move the tip vortex outwards slightly. The centrifugal force is not shown in these figures due to scaling. Gravity also affects the trailing vortex depending on the time scale involved. In other words, the more time having passed or the greater the distance behind the blade, the dip of the vortex due to gravity becomes more pronounced. These tip and trailing vortices reduce propeller efficiency.

The slotted propeller of the present invention is shown on Figure C. The pressure differential between the two sides of the blade produces a flow through the slot. The flow moves upward through the slot, but splits into a circulation around the blade to re-join the flow.

Three circulations are created. A first circulation rotates in the forward direction. A second circulation rotates in the aft direction. A third circulation rotates outward over the tip. The circulation in the forward direction is weaker than the one moving aft. The flow moving over the tip is the strongest of the three.

The flow over the tip weakens the normal tip vortex as the new influence negates the normal tip vortex path. Figure C-1 shows these three circulations when rotation is ignored. Figure C-2 shows these three circulations when rotation is considered. The effect of centrifugal force interacts with the momentum of the circulations rotating them more towards the tip as shown. An even stronger effect is produced to counteract the nominal tip vortex. Therefore, a propeller blade of the present invention is significantly more efficient than other propeller blade configurations in current use. It is also quieter than comparable propeller blades.

The efficiency of the propeller blade of the present invention is a result of ordinary fluid dynamics. Although the invention was tested in a wind tunnel, under unpowered conditions, one skilled in the art can appreciate that the invention will improve the efficiency of any blade operating in any fluid. The invention may be used for powered or unpowered applications. The invention may be used for propellers designed to operate through the air, water, or any other substance with the properties of a fluid.

Although the embodiment disclosed hereafter is a scale model, one skilled in the art would appreciate that the invention can be used in any fluid and scaled to any size.

One example of the improved propeller blade was tested and compared to three other modified propeller blade models and one unmodified propeller blade model. The example of the improved propeller blade was incorporated in a test model comprising a three blade horizontal axis wind turbine designed for low speed operation (wind speeds of 3.5 to 10 m/s). The test model, incorporating the improved propeller blade, comprised a 0.02 m diameter hub from which three transition cylinders 0.01 m in the radial direction gradually transformed into a NACA 63215 airfoil profile at R=0.015 m. The chord at R=0.015 m was 0.022 m and the angle of attack of the airfoil profile was 20 deg with respect to the rotor axis plane. The blade(s) extended to R=0.125m with a chord value of 0.005 m and an angle of attack of −0.5 deg. The total twist of the blade was 20.5 degrees. A slot was cut into each propeller blade, located at quarter chord, spanning from 85% to 95% radius. FIG. 6 depicts the test model incorporating the improved blade, the modification comprising a slot at or near each of the blade tips.

The test model incorporating the improved blade was tested and compared to other models. Each model was identical to the test model except for different known end tip modifications. One unmodified model was used as a base model for comparison and had no end tip modifications, such as tiplets, slots, holes, or cylinders. FIG. 2 depicts the unmodified propeller blade base model. Three other models, incorporating end tip modifications, were tested and compared to the test model, incorporating the improved blade, and the unmodified base model.

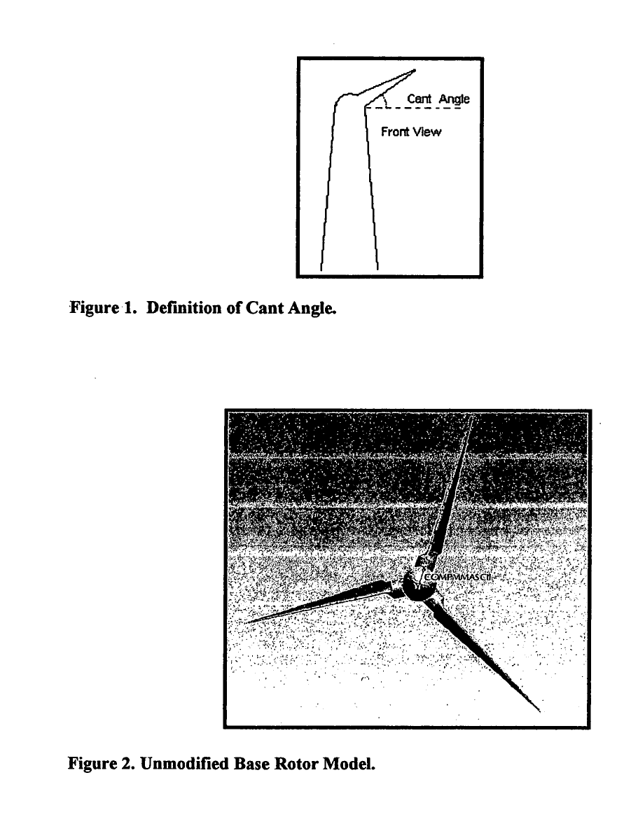

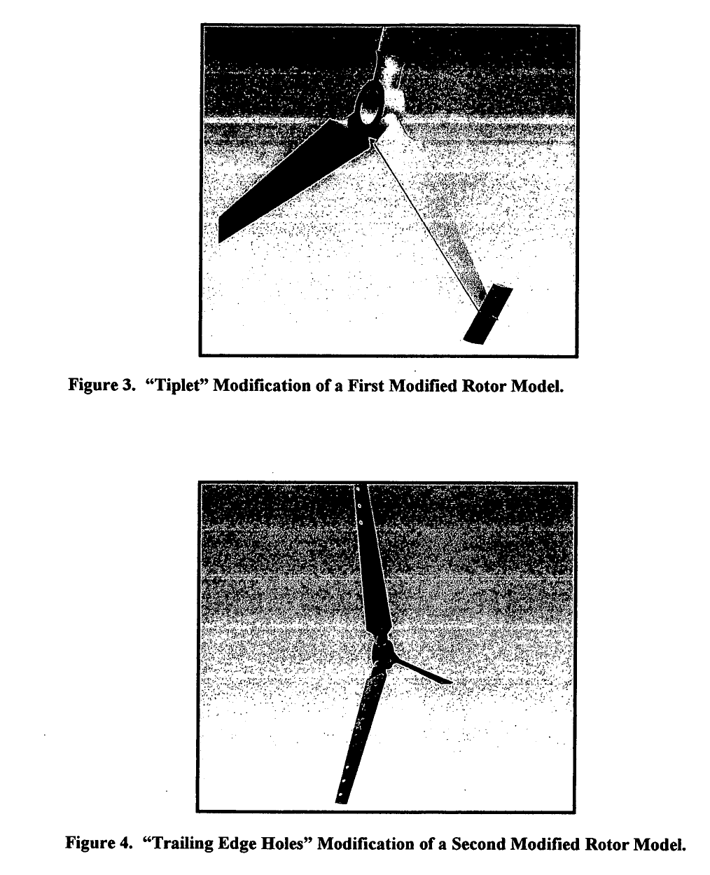

A first modified model modifies each blade with tiplets. The tiplets are symmetric with respect to the plane of rotation and perpendicular to the blade to reduce vibration. The description of a tiplet involves five parameters: airfoil section, span, aspect ratio, twist and cant angle. The cant angle is the angle between the plane perpendicular to the blade and the tiplet plane (FIG. 1). The tiplets have an airfoil section of a NACA 63125, span of 0.005 m, aspect ratio of 1, twist of 0 degrees, and cant angle of 90 degrees. The tiplet parameters were chosen for simplicity, the effect is the same as twisting a 5% span section of an unmodified blade 90 degrees perpendicular to the blade plane in the direction of rotation. The total diameter of the tiplet model is reduced by 5% (compared to the unmodified blade) to keep the total swept area of all models constant. FIG. 3 depicts the tiplet modified propeller blade model.

A second modified model modifies each blade with trailing edge holes. This second model incorporates three trailing edge perforations 0.002 m in diameter at 85%, 90% and 95% radial points. The presence of the perforations is believed to cause pressure equalization between the upper and lower surfaces, thus reducing the intensity of the tip vortex. FIG. 4 depicts the trailing edge holes modified propeller blade model.

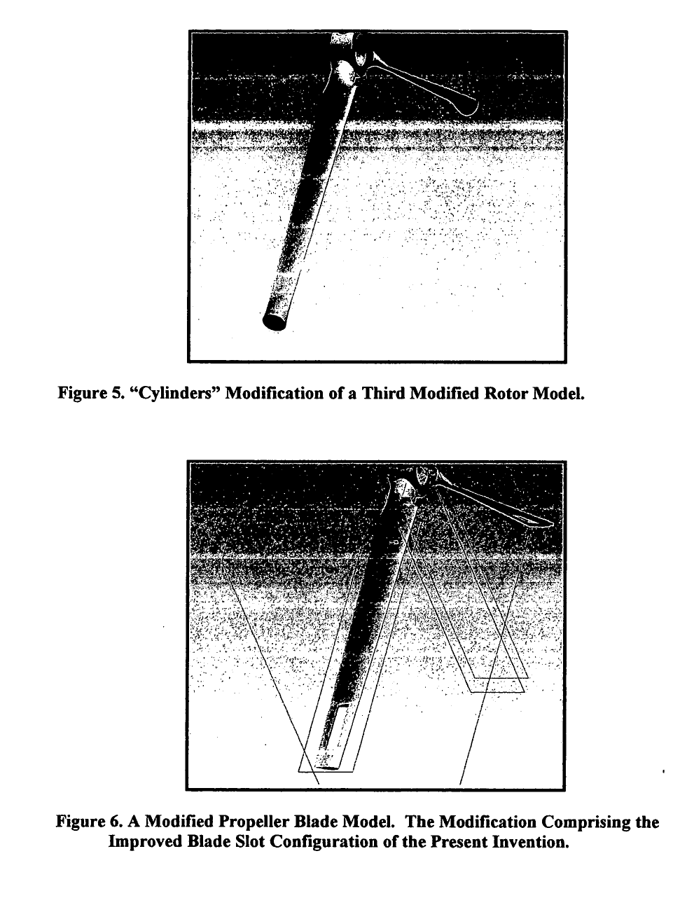

A third modified model modifies each blade with tip cylinders. This third model is modified to include a cylindrical shape at the tip, with a cross section having a radius of 0.01 m. The transition from airfoil structure to cylinder is smooth and begins at 8% radial span. The effect on the trailing vortex is not well known, but the bulbous shape is thought to exaggerate the tip (flow or vortices). Thus this shape is less efficient than the Base model. FIG. 5 depicts the tip cylinders modified propeller blade model.

Power performance tests were conducted on each of the five models (test model Incorporating the improved blade, base model, and three other blade modifications). During the power performance tests, output power from the generator was measured for every whole number velocity ranging from 3 m/s to 20 m/s (omitting the 13 m/s and 14 m/s points) for three different electric load conditions. The total average power for each of the five models shown in table 1.

TABLE 1
Average Power Output in Watts for Each
Model at Each Velocity Setting.

| | | | Trailing | | Test |
|---|---|---|---|---|---|
| Wind Speed | Base | | Edge | Tip | Model |
| (m/s) | Model | Tiplets | Holes | Cylinders | (Slots) |
| 3 | 0.009 | 0.012 | 0.009 | 0.007 | 0.025 |
| 4 | 0.017 | 0.024 | 0.021 | 0.015 | 0.049 |
| 5 | 0.034 | 0.047 | 0.037 | 0.033 | 0.082 |
| 6 | 0.053 | 0.068 | 0.064 | 0.050 | 0.125 |
| 7 | 0.086 | 0.110 | 0.088 | 0.075 | 0.188 |
| 8 | 0.113 | 0.154 | 0.086 | 0.105 | 0.250 |
| 9 | 0.162 | N/A | 0.058 | 0.146 | 0.325 |
| 10 | 0.215 | 0.290 | 0.233 | 0.186 | 0.406 |
| 11 | 0.267 | N/A | 0.095 | 0.237 | 0.494 |
| 12 | 0.347 | 0.431 | 0.371 | 0.295 | 0.598 |
| 15 | 0.506 | 0.614 | 0.515 | 0.446 | 0.859 |
| 16 | 0.607 | 0.744 | 0.585 | 0.512 | 1.048 |
| 17 | 0.698 | 0.843 | 0.737 | 0.594 | 1.187 |
| 18 | 0.814 | 0.990 | 0.878 | 0.459 | 1.342 |
| 19 | 0.918 | 1.083 | 0.934 | 0.734 | 1.457 |
| 20 | 1.066 | 1.218 | 0.929 | 0.745 | 1.617 |

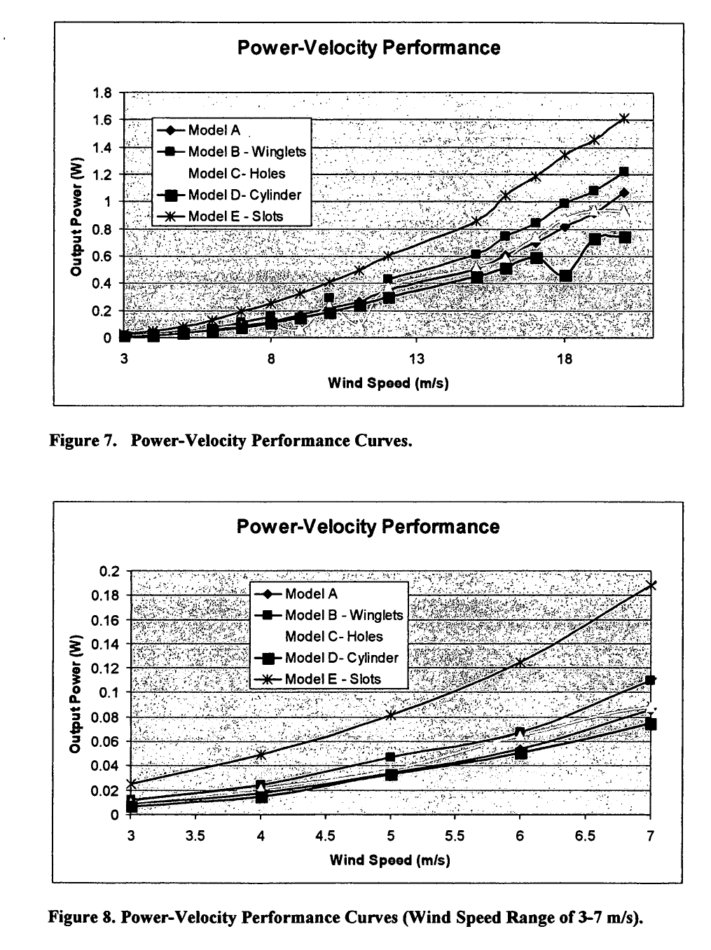

FIG. 7 depicts a Power-Velocity Performance graph. It displays experimentally derived Output Power (W) at various Wind Speeds (m/s) of the three modified propeller blade models, the test model incorporating the improved propeller blade of this invention, and an unmodified propeller blade base model. The base model and the model with trailing edge holes are almost superimposed in the velocity range. FIG. 8 depicts a close-up of the lower velocity ranges for a clear view of the low speed performance.

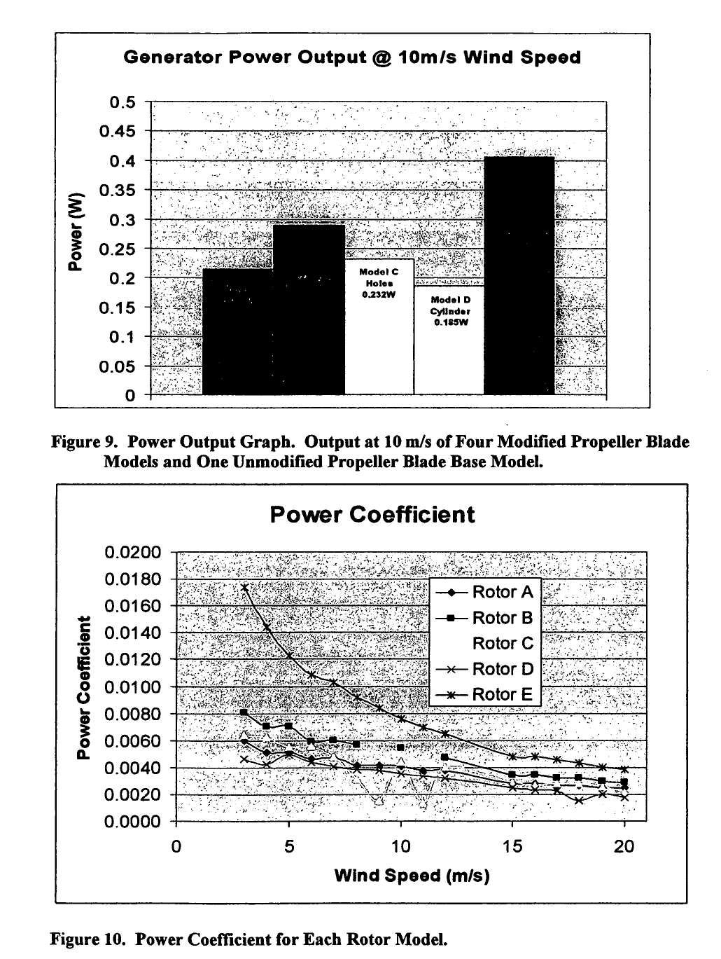

To compare the power output, the graph depicted in FIG. 9 shows the output power at the selected design speed of the rotors, 10 m/s. This comparison shows the greater power output of the test model, incorporating the invention, and the poor power performance of model with the trailing edge holes. Table 2 shows the percentage power difference between each modified model and the base model.

TABLE 2
Power Gain for Each Modified Rotor Model with
Respect to the Power Output of the Base Model.
Power Difference with Control Model (Percentage)

| | | | Trailing | Tip | Test Model |
|---|---|---|---|---|---|
| Wind Speed (m/s) | | Tiptets | Edge Holes | Cylinders | (Slots) |
| | 3 | 33.846 | 6.154 | −23.077 | 188.346 |
| | 4 | 37.405 | 21.374 | −16.985 | 181.832 |
| | 5 | 37.647 | 7.353 | −3.431 | 140.147 |
| | 6 | 27.113 | 20.539 | −5.510 | 133.901 |
| | 7 | 28.271 | 2.921 | −12.582 | 119.965 |
| | 8 | 37.244 | −23.585 | −6.400 | 122.554 |
| | 9 | N/A | −64.131 | −9.524 | 100.802 |
| | 10 | 34.764 | 8.242 | −13.726 | 88.548 |
| | 11 | N/A | −64.379 | −11.286 | 85.334 |
| | 12 | 24.251 | 6.740 | −15.111 | 72.197 |
| | 15 | 21.331 | 1.858 | −11.897 | 69.805 |
| | 16 | 22.484 | −3.655 | −15.712 | 72.516 |
| | 17 | 20.633 | 5.513 | −14.891 | 70.014 |
| | 18 | 21.536 | 7.790 | −43.624 | 64.808 |
| | 19 | 17.953 | 1.735 | −20.022 | 58.675 |
| | 20 | 14.268 | −12.829 | −30.119 | 51.743 |

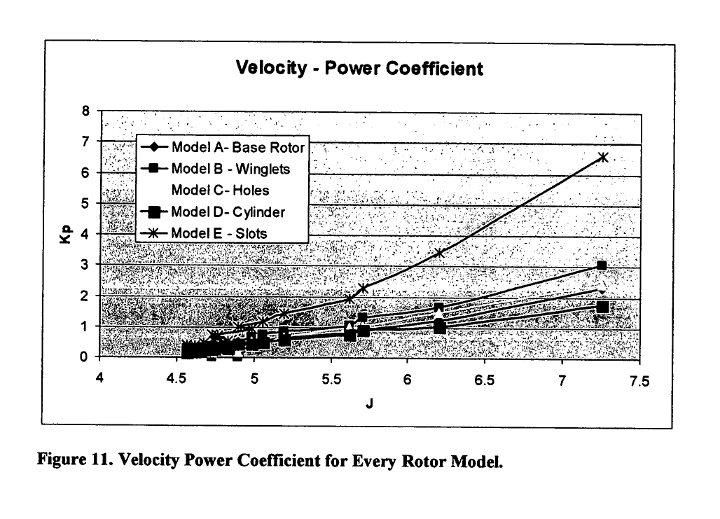

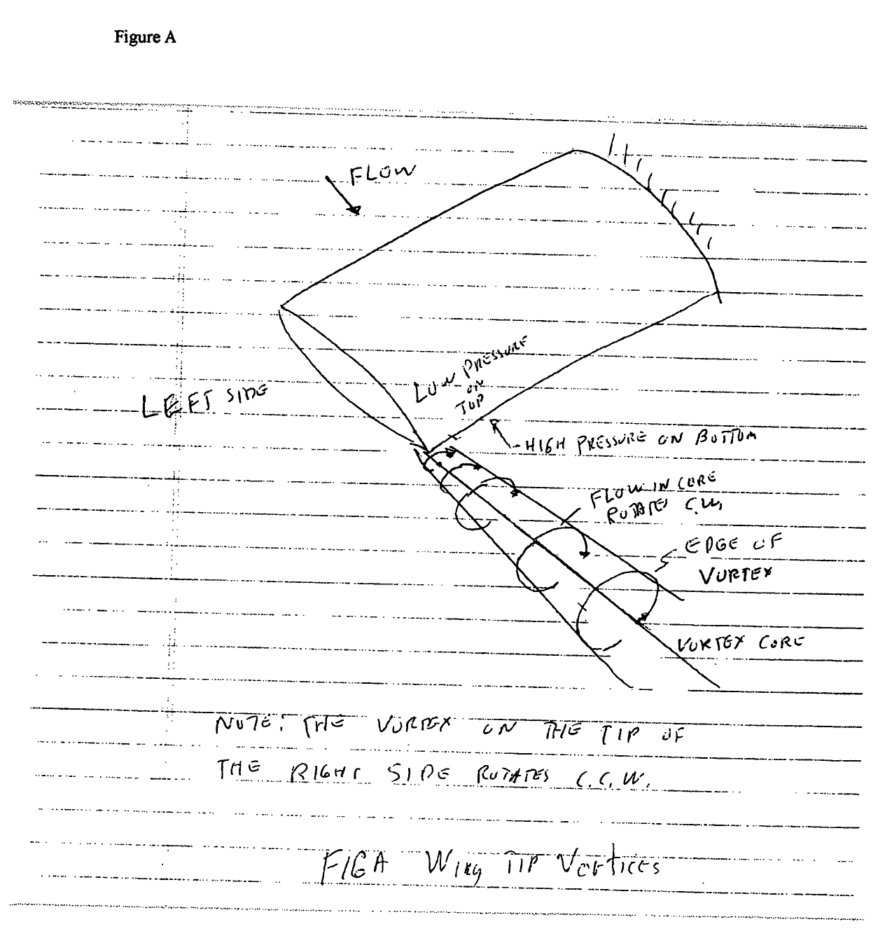

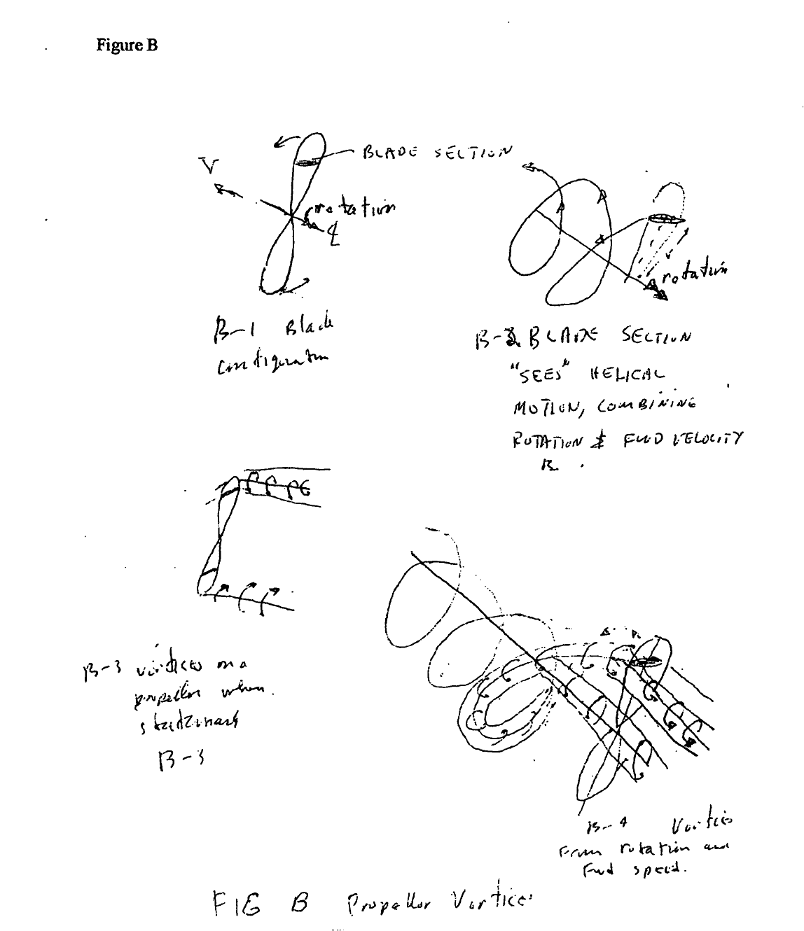

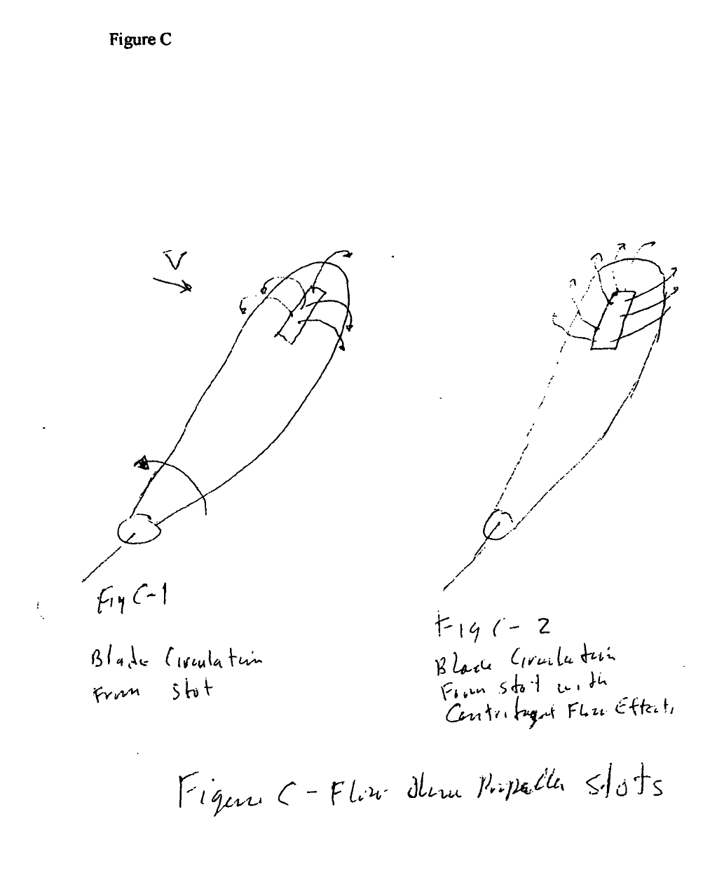

While testing and comparing the five models, only three different circuit loading settings were experimentally studied for a single generator setting which operated away from its maximum efficiency point. Despite this, the graph depicted in FIG. 11 shows that the velocity-power performance of the test model (slots) was better than the other modified models and the unmodified base model.

FIG. 10 depicts a Power Coefficient graph. It displays experimentally derived Power Coefficients at various Wind Speeds (m/s) of four modified propeller blade models and an unmodified propeller blade base model. Model E in FIG. 10 represents the slotted propeller blade of the present invention. As FIG. 10 indicates, the propeller blade of the present invention experiences a greater power coefficient than other comparable propeller blades, especially at lower wind speeds.

The test model, incorporating the improved blades of this invention, produces more power from the same generator at the same velocity setting for every wind free stream velocity than other modified blade models and an unmodified base model. While not wishing to be bound by theory, the effect of the tip slots is believed to produce an energization of the flow around the tip region, reducing the tip vortex normally generated in the outer region of the blade and reduces drag against the rotation-induced velocity component. The modification of the test model, incorporating the improved propeller blade, was located at quarter chord and 85% span location as an illustrative approximation, but a slot of any shape, any chord, any radius, and at any position along the propeller blade could have the same or higher impact in power coefficient. Additionally, the modification of the test model incorporating the improved propeller blade had the slot follow the twist of the blade.

One skilled in the art can appreciate that the slot need not conform to the twist of the blade. Varying the size, shape, and location of the slot within the blade may affect the performance of this invention. One skilled in the art should also appreciate that the size, shape, and location of the slot within the blade may be limited by the physical properties of the blade material.

### REFERENCES

The following references are cited by number throughout this disclosure. Applicant makes no statement, inferred or direct, regarding the status of these references as prior art. Applicant reserves the right to challenge the veracity of statements made in these references, which are incorporated herein by reference.
1. Spera, David A. (Editor), “Wind Turbine Technology.” ASME Publication, 1995.
2. Betz, A., “Windernergie und Ihre Ausnutzung durch Windmuhlen.” Vandenhoeck und Ruprecht, 1926.
3. Kuethe, A. M and Chow, C. Y., “Foundations of Aerodynamics.” Wiley, 1998.
4. Pinzón, C. F., “Experimental Investigation of The Inducement of Vortex Breakdown in a Wing-tip Vortex.” M. S. Thesis, Saint Louis University, 2004.
5. Lanchester, F. W., “Aerodynamics.” 1907. See Bergey, K. H., “The Lanchester-Betz Limit.” Journal of Energy, Vol. 3, No. 6: pp 382-384.
6. Atkins, R. E., “Performance Evaluation of Wind Energy Conversion Systems Using the Method of Bins—Current Status.” SAND 77-1375, Albuquerque.
7. Gyatt and Lissaman, “Development and Testing of Tip Devices for Horizontal Axis Wind Turbines.” NASA CR 174991, 1985.
8. Vermeer, Sorensen, and Crespo, “Wind turbine wake aerodynamics.” Elsevier, 2003.
9. Crespo, M., Moreno, Fraga, and Hernandez, “Numerical Analysis of Wind Turbine Wakes.” Proceedings, Workshop on Wind Energy Application, 1985.
10. Faxen, T, “Wake Interaction in an Array of Windmills.” Proceedings, Second International Symposium on Wind Energy Systems, 1978.
11. Cheremisinoff, N. P., “Fundamental of wind energy.” Ann Arbor Science, 1978.
12. Walker, J., and Jenkins, N., “Wind Energy Technology”. Wiley and Sons, 1997.
13. “Wings for all speeds”, http://aerodyn.org/Drag/tip_devices.html
14. Barrio-Crespo, H., “Comparative Power Study of Horizontal Axis Wind Turbines with Blade Modifications”. M. S. Thesis, Saint Louis University, Dec. 2005.
15. Barrio, H. and Ferman, M., “Evaluation of New Propeller Concepts for Wind Turbines,” EAA Air Venture 2005, Osh Kosh WI, 25-31 Jul. 2005.

What is claimed is:

1. A modified propeller blade comprising a tip modification, wherein (a) the modified propeller blade is capable of increasing the power output of a turbine that comprises modified propeller blades, and (b) the increasing the power output is relative to the power output of a turbine that comprises unmodified propeller blades.

2. The modified propeller blade of claim 1, wherein the tip modification is selected from the group consisting of (a) slots, (b) holes, (c) cylinders and (d) winglets.

3. The modified propeller blade of claim 2, wherein the tip modification is at least one slot.

4. The modified propeller blade of claim 3, wherein the at least one slot is rectangular in shape.

5. The modified propeller blade of claim 3, wherein the length of the at least one slot is anywhere in the range of 1% to 25% of the blade radius.

6. The modified propeller blade of claim 5, wherein the at least one slot begins at a first radius and ends at a second radius along the blade, the first radius lies anywhere in the range of 50% to 99% of the blade radius, the second radius lies anywhere in the range of 51% to 100% of the blade radius, and the second radius is greater than the first.

7. The modified propeller blade of claim 3, wherein the width of the at least one slot is anywhere in the range of 1% to 99% of the blade chord.

8. The modified propeller blade of claim 7, wherein the at least one slot is centered on the blade with respect to chord.

9. A modified propeller blade comprising a slot, wherein (a) the modified propeller blade is capable of increasing the power output of a turbine that comprises modified propeller blades, (b) the increasing the power output is relative to the power output of a turbine that comprises unmodified propeller blades having a similar size and shape to the modified propeller blade, and (c) the slot is located at quarter chord and located near the tip of the blade, spanning from 85% to 95% radius.

10. A method of generating power using a modified propeller blade as set forth in any one of claims 1 through 9.

11. A method of propulsion using a modified propeller blade as set forth in any one of claims 1 through 9.
